(19) United States
(12) Patent Application Publication
(10) Pub. No.: US 2015/0236635 A1
(43) Pub. Date: Aug. 20, 2015

(54) INVERTER OUTPUT CIRCUIT

(71) Applicant: KABUSHIKI KAISHA TOSHIBA, Tokyo (JP)

(72) Inventor: Yuichi GOTO, Hiratsuka Kanagawa (JP)

(21) Appl. No.: 14/327,746

(22) Filed: Jul. 10, 2014

(30) Foreign Application Priority Data
Feb. 14, 2014 (JP) 2014-026310

(51) Int. Cl. H02P 27/06

(52) U.S. Cl. CPC H02P 27/06

(57) ABSTRACT

An inverter output circuit for a motor that is connected to first and second nodes includes a first MOS transistor connected between a power supply line and the first node, a second MOS transistor connected between the first node and a third node, a third MOS transistor connected between the power supply line and the second node, a fourth MOS transistor connected between the second node and the third node, and a fifth MOS transistor having a first end connected to the third node and a second end connected to ground. The inverter output circuit further includes a voltage detection circuit which detects a negative voltage, and turns off the fifth MOS transistor when the negative voltage is equal to or higher than a negative reference voltage, and turns on the fifth MOS transistor when the negative voltage is lower than the negative reference voltage.

### CROSS-REFERENCE TO RELATED APPLICATION

This application is based upon and claims the benefit of priority from Japanese Patent Application No. 2014-026310, filed Feb. 14, 2014, the entire contents of which are incorporated herein by reference.

### FIELD

Embodiments described herein relate generally to an inverter output circuit.

### BACKGROUND

Inverter output circuits for motor control or the like according to the related art employ normally-off MOS transistors such as enhancement-type MOSFETs, as output elements. Recently, in order for improve efficiency, normally-on MOS transistors, such as high electron mobility transistors and depletion-type MOSFETs, having improved on-resistance and switching speeds have been applied to those inverter output circuits. In order to turn off an output element described above, it is necessary to apply negative voltages to the gate and source of a normally-on MOS transistor having the output element.

### DESCRIPTION OF THE DRAWINGS

FIG. 1 is a circuit diagram illustrating an example configuration of an inverter output circuit according to a first embodiment.

FIGS. 2A and 2B are circuit diagrams illustrating example circuit configurations of a first inverter and a second inverter of the inverter output circuit illustrated in FIG. 1, respectively.

FIG. 3 is a circuit diagram illustrating an example configuration of an inverter output circuit 200 according to a second embodiment.

### DETAILED DESCRIPTION

Embodiments provide an inverter output circuit capable of applying sufficient and negative voltages to output elements.

In general, according to one embodiment, an inverter output circuit for a motor that is connected to first and second nodes includes a normally-on type first MOS transistor connected between a power supply line and the first node, a normally-on type second MOS transistor connected between the first node and a third node, a normally-on type third MOS transistor connected between the power supply line and the second node, and a normally-on type fourth MOS transistor connected between the second node and the third node. The inverter output circuit further includes a first inverter having an input portion to which a first control signal is supplied and an output portion which is connected to a gate of the first MOS transistor, a first power supply node which is connected to the first node, and a second power supply node, a second inverter having an input portion to which a second control signal is supplied and an output portion which is connected to a gate of the second MOS transistor, a third power supply node which is connected to ground, and a fourth power supply node, a third inverter having an input portion to which a third control signal is supplied and an output portion which is connected to a gate of the third MOS transistor, a fifth power supply node which is connected to the second node, and a sixth power supply node, a fourth inverter having an input portion to which a fourth control signal is supplied, an output portion which is connected to a gate of the fourth MOS transistor, a seventh power supply node which is connected to ground, and an eighth power supply node which is connected to the fourth power supply node, a fifth MOS transistor having a first end connected to the third node and a second end connected to ground, and a voltage detection circuit configured to detect a negative voltage lower than a ground voltage supplied to the fourth and eighth power supply nodes, and to turn off the fifth MOS transistor when the negative voltage is equal to or higher than a negative reference voltage and turn on the fifth MOS transistor when the negative voltage is lower than the negative reference voltage.

Hereinafter, embodiments will be described with reference to the accompanying drawings.

### First Embodiment

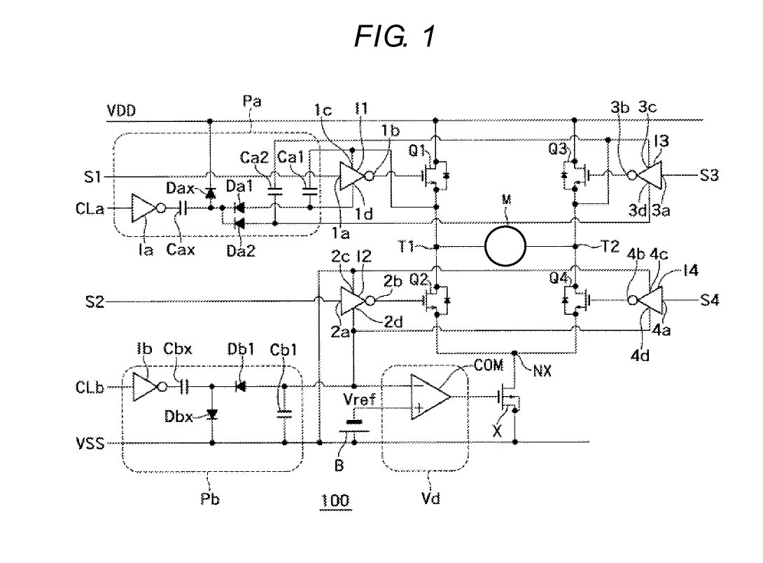

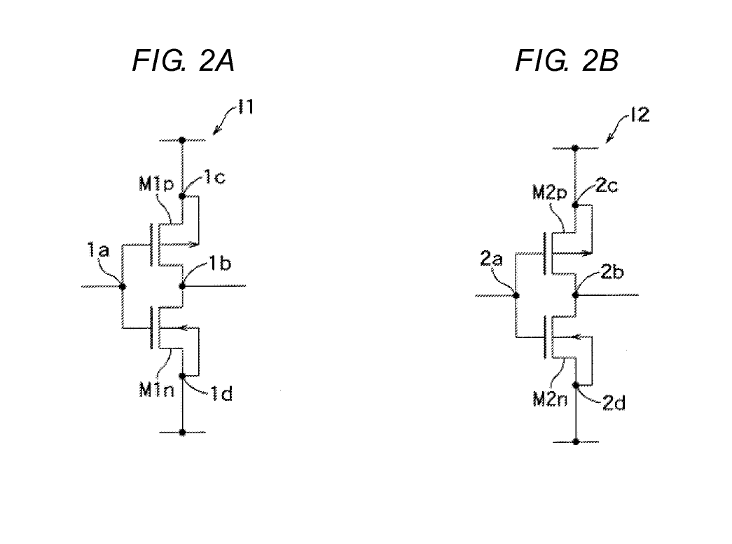

FIG. 1 is a circuit diagram illustrating an example configuration of an inverter output circuit 100 according to a first embodiment. Also, FIGS. 2A and 2B are circuit diagrams illustrating example circuit configurations of a first inverter I1 and a second inverter I2 of the inverter output circuit 100 illustrated in FIG. 1, respectively.

As illustrated in FIG. 1, a motor (here, a single-phase motor) M is connected between a first output terminal (node) T1 and a second output terminal (node) T2.

Further, the inverter output circuit 100 supplies a driving current to a coil of the single-phase motor from the first output terminal T1 and the second output terminal T2 in response to first to fourth control signals S1 to S4, such that the single-phase motor is driven.

For example, as illustrated in FIG. 1, the inverter output circuit 100 includes a normally-on type first MOS transistor Q1, a normally-on type second MOS transistor Q2, a normally-on type third MOS transistor Q3, a normally-on type fourth MOS transistor Q4, the first inverter I1, the second inverter I2, a third inverter I3, a fourth inverter I4, a power supply side charge pump Pa, a ground side charge pump Pb, a normally-on type switching MOS transistor X, a voltage detection circuit Vd, and a reference voltage generating circuit B.

One end (drain) of the first MOS transistor Q1 is connected to a power supply line VDD, and another end (source) thereof is connected to the first output terminal T1.

One end (drain) of the second MOS transistor Q2 is connected to the first output terminal T1, and another end (source) thereof is connected to a connection node NX.

One end (drain) of the third MOS transistor Q3 is connected to the power supply line VDD, and another end (source) thereof is connected to the second output terminal T2.

One end (drain) of the fourth MOS transistor Q4 is connected to the second output terminal T2, and another end (source) thereof is connected to the connection node NX.

Also, the normally-on type first to fourth MOS transistors Q1 to Q4, which are output elements, are depletion-type MOS transistors, and are manufactured using wide band gap semiconductors of, for example, GaN.

The first inverter I1 includes an input portion 1a to which the first control signal S1 is supplied, and an output portion 1b which is connected to the gate of the first MOS transistor Q1. The first inverter I1 includes a first power supply node 1c, which is connected to the other end of the first MOS transistor Q1, and a second power supply node 1d.

For example, as illustrated in FIG. 2A, the first inverter I1 includes a pMOS transistor M1p and an nMOS transistor M1n. The pMOS transistor M1p includes a source which is connected to the first power supply node 1c, a drain which is connected to the output portion 1b, and a gate which is connected to the input portion 1a, and the nMOS transistor M1n includes a drain which is connected to the second power supply node 1d, a source which is connected to the output portion 1b, and a gate which is connected to the input portion 1a.

The first inverter I1 inverts a signal supplied to the input portion 1a, and outputs the inverted signal through the output portion 1b.

Also, the third inverter I3 has the same circuit configuration as that of the first inverter I1 illustrated in FIG. 2A.

The second inverter I2 includes an input portion 2a to which the second control signal S2 is supplied, and an output portion 2b which is connected to the gate of the second MOS transistor Q2. The second inverter I2 includes a third power supply node 2c which is connected to the ground line VSS, and a fourth power supply node 2d which is connected to an output of the ground side charge pump Pb.

For example, as illustrated in FIG. 2B, the second inverter I2 includes a pMOS transistor M2p and a nMOS transistor M2n. The pMOS transistor M2p includes a source which is connected to the third power supply node 2c, a drain which is connected to the output portion 2b, and a gate which is connected to the input portion 2a, and the nMOS transistor M2n includes a drain which is connected to the fourth power supply node 2d, a source which is connected to the output portion 2b, and a gate which is connected to the input portion 2a.

The second inverter I2 inverts a signal supplied to the input portion 2a, and outputs the inverted signal through the output portion 2b.

Also, the fourth inverter I4 has the same circuit configuration as that of the second inverter I2 illustrated in FIG. 2B.

Also, the third inverter I3 includes an input portion 3a to which the third control signal S3 is supplied, and an output portion 3b which is connected to the gate of the third MOS transistor Q3. The third inverter I3 includes a fifth power supply node 3c which is connected to the other end of the third MOS transistor Q3, and a sixth power supply node 3d.

The fourth inverter I4 includes an input portion 4a to which the fourth control signal S4 is supplied, and an output portion 4b which is connected to the gate of the fourth MOS transistor Q4. The fourth inverter I4 includes a seventh power supply node 4c which is connected to the ground line VSS, and an eighth power supply node 4d which is connected to the fourth power supply node 2d.

The power supply side charge pump Pa supplies a first high voltage to the first power supply node 1c while supplying a first low voltage lower than the first high voltage to the second power supply node 1d. Further, the power supply side charge pump Pa supplies a second high voltage to the fifth power supply node 3c while supplying a second low voltage lower than the second high voltage to the sixth power supply node 3d.

For example, as illustrated in FIG. 1, the power supply side charge pump Pa includes a first inverter Ia, a first capacitor Cax, a first diode Dax, a first power supply side diode Da1, a second power supply side diode Da2, a first power supply side capacitor Ca1, and a second power supply side capacitor Ca2.

The first inverter Ia receives a first clock signal CLa. One end of the first capacitor Cax is connected to the output of the first inverter Ia.

The anode of the first diode Dax is connected to the other end of the first capacitor Cax, and the cathode thereof is connected to the power supply line VDD.

The cathode of the first power supply side diode Da1 is connected to the other end of the first capacitor Cax, and the anode thereof is connected to the second power supply node 1d.

The cathode of the second power supply side diode Da2 is connected to the other end of the first capacitor Cax, and the anode thereof is connected to the sixth power supply node 3d.

One end of the first power supply side capacitor Ca1 is connected to the first power supply node 1c, and the other end thereof is connected to the second power supply node 1d.

One end of the second power supply side capacitor Ca2 is connected to the fifth power supply node 3c, and the other end thereof is connected to the sixth power supply node 3d.

In response to the first clock signal CLa, the power supply side charge pump Pa outputs the first and second high voltages while outputting the first and second low voltages.

The ground side charge pump Pb supplies negative voltages lower than the ground voltage of the ground line VSS to the fourth and eighth power supply nodes 2d and 4d.

For example, as illustrated in FIG. 1, the ground side charge pump Pb includes a second inverter Ib, a second capacitor Cbx, a second diode Dbx, a ground side diode Db1, and a ground side capacitor Cb1.

The second inverter Ib receives a second clock signal CLb.

One end of the second capacitor Cbx is connected to the output of the second inverter Ib.

The anode of the second diode Dbx is connected to the other end of the second capacitor Cbx, and the cathode thereof is connected to the ground line VSS.

The cathode of the ground side diode Db1 is connected to the other end of the second capacitor Cbx, and the anode thereof is connected to the fourth power supply node 2d.

One end of the ground side capacitor Cb1 is connected to the third power supply node 2c, and the other end thereof is connected to the fourth power supply node 2d.

The ground side charge pump Pb outputs a negative voltage in response to the second clock signal CLb.

Also, one end of the switching MOS transistor X is connected to the connection node NX, and the other end thereof is connected to the ground line VSS.

The switching MOS transistor X is an enhancement-type MOS transistor, and is manufactured using a wide band gap semiconductor of, for example, GaN. Further, the switching MOS transistor X has a breakdown voltage lower than those of the normally-on type first to fourth MOS transistors Q1 to Q4.

Also, the reference voltage generating circuit B generates a negative reference voltage Vref lower than the ground voltage.

The voltage detection circuit Vd detects the negative voltage output from the ground side charge pump Pb. Further, the voltage detection circuit Vd turns off the switching MOS transistor X in a case where the negative voltage is equal to or higher than the negative reference voltage Vref, and turns on the switching MOS transistor X in a case where the negative voltage is lower than the negative reference voltage Vref.

For example, as illustrated in FIG. 1, the voltage detection circuit Vd is a comparator COM which includes a non-inverted input terminal to which the reference voltage Vref is supplied, an inverted input terminal which is connected to the fourth power supply node 2d, and an output which is connected to the gate of the switching MOS transistor X.

Now, the operation characteristic of the inverter output circuit 100 according to the first embodiment having the above described configuration will be described.

As described above, the switching MOS transistor X of the inverter output circuit 100 is an enhancement-type MOS transistor which is of a normally-off type, and the first to fourth MOS transistors Q1 to Q4, which are output elements, are depletion-type MOS transistors which are of a normally-on type.

For example, in a case where the negative voltage is equal to or higher than the negative reference voltage Vref, the voltage detection circuit Vd turns off the switching MOS transistor X.

Therefore, during a condition where the negative voltage for driving the second MOS transistor Q2 and the fourth MOS transistor Q4 which are output elements is not at a sufficient potential, a current (consumption current) flowing to the output elements is interrupted. As a result, it is possible to prevent destruction of the output elements and to reduce the consumption current of the system during standby or the like.

Meanwhile, in a case where the negative voltage is lower than the negative reference voltage Vref, the voltage detection circuit Vd turns on the switching MOS transistor X.

Therefore, during a condition where the negative voltage for driving the second MOS transistor Q2 and the fourth MOS transistor Q4 which are output elements is at a sufficient potential, currents flow in the output elements. That is, in response to the first to fourth control signals S1 to S4, a driving current may be supplied from the first output terminal T1 and the second output terminal T2 to the coil of the single-phase motor, thereby driving the single-phase motor.

As described above, according to the inverter output circuit according to the first embodiment, it is possible to reduce the consumption current and suppress destruction of the output elements.

### Second Embodiment

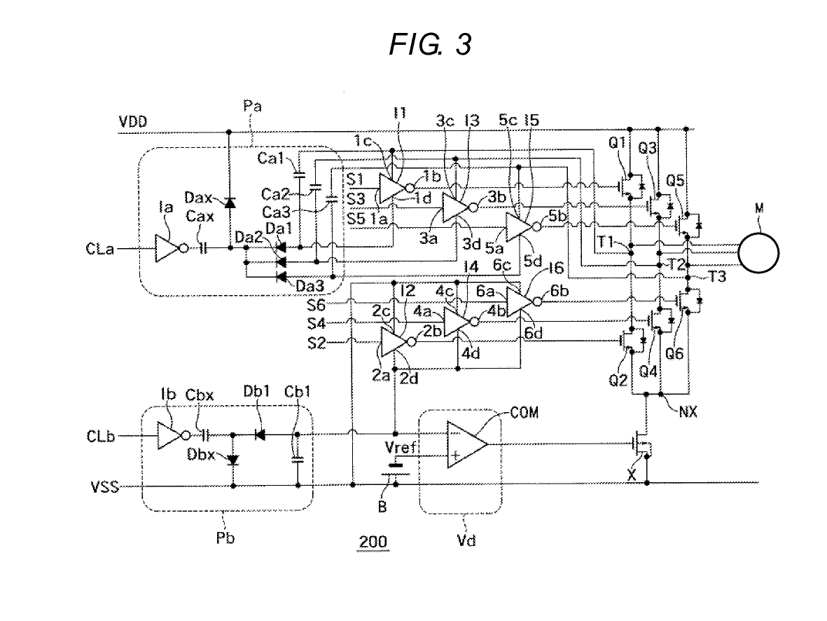

FIG. 3 is a circuit diagram illustrating an example configuration of an inverter output circuit 200 according to the second embodiment. In FIG. 3, the same reference symbols as reference symbols of FIG. 1 denote components identical to those of the first embodiment.

As illustrated in FIG. 3, a first output terminal (node) T1, a second output terminal (node) T2, and a third output terminal T3 are connected to a motor (here, a three-phase motor) M.

Further, in response to first to sixth control signals S1 to S6, the inverter output circuit 200 supplies a driving current from the first output terminal T1, the second output terminal T2, and the third output terminal T3 to the coils of the three-phase motor, thereby driving the three-phase motor.

For example, as illustrated in FIG. 3, the inverter output circuit 200 includes a normally-on type first MOS transistor Q1, a normally-on type second MOS transistor Q2, a normally-on type third MOS transistor Q3, a normally-on type fourth MOS transistor Q4, a normally-on type fifth MOS transistor Q5, a normally-on type sixth MOS transistor Q6, a first inverter I1, a second inverter I2, a third inverter I3, a fourth inverter I4, a fifth inverter I5, a sixth inverter I6, a power supply side charge pump Pa, a ground side charge pump Pb, a normally-on type switching MOS transistor X, a voltage detection circuit Vd, and a reference voltage generating circuit B.

That is, as compared to the inverter output circuit 100 according to the first embodiment, the inverter output circuit 200 further includes the normally-on type fifth MOS transistor Q5, the normally-on type sixth MOS transistor Q6, the fifth inverter I5, and the sixth inverter I6.

One end (drain) of the fifth MOS transistor Q5 is connected to a power supply line VDD, and the other end (source) thereof is connected to the third output terminal I3.

One end (drain) of the sixth MOS transistor Q6 is connected to the third output terminal T3, and another end thereof is connected to a connection node NX.

Also, the fifth inverter I5 includes an input portion 5a to which the fifth control signal S5 is supplied, and an output portion 5b which is connected to the gate of the fifth MOS transistor Q5. The fifth inverter I5 includes a ninth power supply node 5c which is connected to the power supply line VDD, and a tenth power supply node 5d.

Also, the fifth inverter I5 has the same circuit configuration as that of the first inverter I1 illustrated in FIG. 2A.

The sixth inverter I6 includes an input portion 6a to which the sixth control signal S6 is supplied, and an output portion 6b which is connected to the gate of the sixth MOS transistor Q6. The sixth inverter I6 includes an eleventh power supply node 6c which is connected to the ground line VSS, and a twelfth power supply node 6d which is connected to the fourth power supply node 2d.

Also, the sixth inverter I6 has the same circuit configuration as that of the second inverter I2 illustrated in FIG. 2B.

Here, as compared to the first embodiment, the power supply side charge pump Pa further includes a third power supply side diode Da3 and a third power supply side capacitor Ca3, for example, as illustrated in FIG. 3.

The cathode of the third power supply side diode Da3 is connected to the other end of the first capacitor Cax, and the anode thereof is connected to the tenth power supply node 5d.

One end of the third power supply side capacitor Ca3 is connected to the ninth power supply node 5c, and the other end thereof is connected to the tenth power supply node 5d.

That is, as compared to the first embodiment, the power supply side charge pump Pa further supplies a third high voltage to the ninth power supply node 5c while supplying a third low voltage lower than the third high voltage to the tenth power supply node 5d.

Further, as compared to the first embodiment, the ground side charge pump Pb further supplies the negative voltage to the twelfth power supply node 6d.

The other configuration and functions of the inverter output circuit 200 are the same as those of the inverter output circuit 100 according to the first embodiment.

Further, the operation characteristic of the inverter output circuit 200 according to the present embodiment is also the same as that of the inverter output circuit 100 according to the first embodiment.

For example, in a case where the third low voltage is equal to or higher than the negative reference voltage Vref, the voltage detection circuit Vd turns off the switching MOS transistor X.

Therefore, during a condition where the negative voltage for driving the second, fourth, and sixth MOS transistors Q2, Q4, and Q6 which are output elements is not at a sufficient potential, a current (consumption current) flowing to those output elements is interrupted. As a result, it is possible to prevent destruction of the output elements and to reduce the consumption current of the system during standby or the like.

Meanwhile, in a case where the negative voltage is lower than the negative reference voltage Vref, the voltage detection circuit Vd turns on the switching MOS transistor X.

Therefore, during a condition where the negative voltage for driving the second, fourth, and sixth MOS transistors Q2, Q4, and Q6 which are output elements is at a sufficient potential, currents flow to the output elements. That is, in response to the first to sixth control signals S1 to S6, a driving current may be supplied from the first output terminal T1, the second output terminal T2, and the third output terminal T3 to the coils of the three-phase motor, thereby driving the three-phase motor.

As described above, according to the inverter output circuit according to the present embodiment, it is possible to reduce the consumption current and suppress destruction of the output elements.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inverter output circuit for a motor that is connected between first and second nodes, comprising:
a normally-on type first MOS transistor connected between a power supply line and the first node;
a normally-on type second MOS transistor connected between the first node and a third node;
a normally-on type third MOS transistor connected between the power supply line and the second node;
a normally-on type fourth MOS transistor connected between the second node and the third node;
a first inverter having an input portion to which a first control signal is supplied and an output portion which is connected to a gate of the first MOS transistor, a first power supply node which is connected to the first node, and a second power supply node;
a second inverter having an input portion to which a second control signal is supplied and an output portion which is connected to a gate of the second MOS transistor, a third power supply node which is connected to ground, and a fourth power supply node;
a third inverter having an input portion to which a third control signal is supplied and an output portion which is connected to a gate of the third MOS transistor, a fifth power supply node which is connected to the second node, and a sixth power supply node;
a fourth inverter having an input portion to which a fourth control signal is supplied, an output portion which is connected to a gate of the fourth MOS transistor, a seventh power supply node which is connected to ground, and an eighth power supply node which is connected to the fourth power supply node;
a fifth MOS transistor having a first end connected to the third node and a second end connected to ground; and
a voltage detection circuit configured to detect a negative voltage lower than a ground voltage supplied to the fourth and eighth power supply nodes, and to turn off the fifth MOS transistor when the negative voltage is equal to or higher than a negative reference voltage and turn on the fifth MOS transistor when the negative voltage is lower than the negative reference voltage.

2. The inverter output circuit according to claim 1, wherein the fifth MOS transistor is a normally-off type MOS transistor.

3. The inverter output circuit according to claim 1, wherein
the normally-on type first to fourth MOS transistors are depletion-type MOS transistors, and
the fifth MOS transistor is an enhancement-type MOS transistor.

4. The inverter output circuit according to claim 1, wherein
the fifth MOS transistor has a breakdown voltage lower than those of the normally-on type first to fourth MOS transistors.

5. The inverter output circuit according to claim 1, further comprising:
a ground side charge pump configured to supply the negative voltage lower than the ground voltage to the fourth and eighth power supply nodes.

6. The inverter output circuit according to claim 5, further comprising:
a power supply side charge pump configured to supply a first high voltage to the first power supply node while supplying a first low voltage lower than the first high voltage to the second power supply node, and to supply a second high voltage to the fifth power supply node while supplying a second low voltage lower than the second high voltage to the sixth power supply node.

7. The inverter output circuit according to claim 6, wherein the power supply side charge pump includes:
a fifth inverter to which a first clock signal is input;
a first capacitor having a first end connected to an output of the fifth inverter;
a first diode having an anode connected to a second end of the first capacitor and a cathode connected to the power supply line;
a first power supply side diode having a cathode connected to the second end of the first capacitor and an anode connected to the second power supply node;
a second power supply side diode having a cathode connected to the second end of the first capacitor and an anode connected to the sixth power supply node;
a first power supply side capacitor having a first end connected to the first power supply node and a second end connected to the second power supply node; and
a second power supply side capacitor having a first end connected to the fifth power supply node and a second end connected to the sixth power supply node.

8. The inverter output circuit according to claim 7, wherein the ground side charge pump includes:
a sixth inverter to which a second clock signal is input;
a second capacitor having a first end connected to an output of the sixth inverter;
a second diode having an anode connected to a second end of the second capacitor and a cathode connected to ground;
a ground side diode having a cathode connected to the second end of the second capacitor and an anode connected to the fourth power supply node; and
a ground side capacitor having a first end connected to the third power supply node and a second end connected to the fourth power supply node.

9. The inverter output circuit according to claim 1, wherein
the voltage detection circuit is a comparator which includes a non-inverted input terminal to which the reference voltage is supplied, an inverted input terminal which is connected to the fourth power supply node, and an output terminal which is connected to a gate of the fifth MOS transistor.

10. The inverter output circuit according to claim 1, further comprising:
a reference voltage generating circuit configured to generate the negative reference voltage lower than the ground voltage.

11. An inverter output circuit for a motor that is connected to first, second, and third nodes, comprising:
a normally-on type first MOS transistor connected between a power supply line and the first node;
a normally-on type second MOS transistor connected between the first node and a fourth node;
a normally-on type third MOS transistor connected between the power supply line and the second node;
a normally-on type fourth MOS transistor connected between the second node and the fourth node;
a normally-on type third MOS transistor connected between the power supply line and the third node;
a normally-on type fourth MOS transistor connected between the third node and the fourth node;
a first inverter having an input portion to which a first control signal is supplied and an output portion which is connected to a gate of the first MOS transistor, a first power supply node which is connected to the first node, and a second power supply node;
a second inverter having an input portion to which a second control signal is supplied and an output portion which is connected to a gate of the second MOS transistor, a third power supply node which is connected to ground, and a fourth power supply node;
a third inverter having an input portion to which a third control signal is supplied and an output portion which is connected to a gate of the third MOS transistor, a fifth power supply node which is connected to the second node, and a sixth power supply node;
a fourth inverter having an input portion to which a fourth control signal is supplied, an output portion which is connected to a gate of the fourth MOS transistor, a seventh power supply node which is connected to ground, and an eighth power supply node which is connected to the fourth power supply node;
a fifth inverter having an input portion to which a fifth control signal is supplied and an output portion which is connected to a gate of the fifth MOS transistor, a ninth power supply node which is connected to the third node, and a tenth power supply node;
a sixth inverter having an input portion to which a sixth control signal is supplied, an output portion which is connected to a gate of the sixth MOS transistor, an eleventh power supply node which is connected to ground, and a twelfth power supply node which is connected to the fourth power supply node;
a seventh MOS transistor having a first end connected to the fourth node and a second end connected to ground; and
a voltage detection circuit configured to detect a negative voltage lower than a ground voltage supplied to the fourth, eighth, and twelfth power supply nodes, and to turn off the seventh MOS transistor when the negative voltage is equal to or higher than a negative reference voltage and turn on the seventh MOS transistor when the negative voltage is lower than the negative reference voltage.

12. The inverter output circuit according to claim 11, wherein the seventh MOS transistor is a normally-off type MOS transistor.

13. The inverter output circuit according to claim 11, wherein
the normally-on type first to sixth MOS transistors are depletion-type MOS transistors, and
the seventh MOS transistor is an enhancement-type MOS transistor.

14. The inverter output circuit according to claim 11, wherein
the seventh MOS transistor has a breakdown voltage lower than those of the normally-on type first to fourth MOS transistors.

15. The inverter output circuit according to claim 11, further comprising:
a ground side charge pump configured to supply the negative voltage lower than the ground voltage to the fourth, eighth, and twelfth power supply nodes.

16. The inverter output circuit according to claim 15, further comprising:
a power supply side charge pump configured to supply a first high voltage to the first power supply node while supplying a first low voltage lower than the first high voltage to the second power supply node, to supply a second high voltage to the fifth power supply node while supplying a second low voltage lower than the second high voltage to the sixth power supply node, and to supply a third high voltage to the seventh power supply node while supplying a third low voltage lower than the third high voltage to the eighth power supply node.

17. The inverter output circuit according to claim 16, wherein the power supply side charge pump includes:
a seventh inverter to which a first clock signal is input;
a first capacitor having a first end connected to an output of the seventh inverter;
a first diode having an anode connected to a second end of the first capacitor and a cathode connected to the power supply line;
a first power supply side diode having a cathode connected to the second end of the first capacitor and an anode connected to the second power supply node;
a second power supply side diode having a cathode connected to the second end of the first capacitor and an anode connected to the sixth power supply node;
a third power supply side diode having a cathode connected to the second end of the first capacitor and an anode connected to the tenth power supply node;
a first power supply side capacitor having a first end connected to the first power supply node and a second end connected to the second power supply node;
a second power supply side capacitor having a first end connected to the fifth power supply node and a second end connected to the sixth power supply node; and
a third power supply side capacitor having a first end connected to the ninth power supply node and a second end connected to the tenth power supply node.

18. The inverter output circuit according to claim 17, wherein the ground side charge pump includes:
an eighth inverter to which a second clock signal is input;
a second capacitor having a first end connected to an output of the eighth inverter;
a second diode having an anode connected to a second end of the second capacitor and a cathode connected to ground;
a ground side diode having a cathode connected to the second end of the second capacitor and an anode connected to the fourth power supply node; and
a ground side capacitor having a first end connected to the third power supply node and a second end connected to the fourth power supply node.

19. The inverter output circuit according to claim 11, wherein
the voltage detection circuit is a comparator which includes a non-inverted input terminal to which the reference voltage is supplied, an inverted input terminal which is connected to the fourth power supply node, and an output terminal which is connected to a gate of the fifth MOS transistor.

20. The inverter output circuit according to claim 11, further comprising:
a reference voltage generating circuit configured to generate the negative reference voltage lower than the ground voltage.
